(19) United States
(12) Patent Application Publication
(10) Pub. No.: US 2006/0245457 A1
(43) Pub. Date: Nov. 2, 2006

(54) System for adjusting optical characteristics and method thereof

(75) Inventors: Huai-Pei Chen, Taoyuan Hsien (TW); Chun-Lin Kuo, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONIC, INC.

(21) Appl. No.: 11/349,191

(22) Filed: Feb. 8, 2006

(30) Foreign Application Priority Data
Feb. 25, 2005 (TW) 94105752

(51) Int. Cl. H01S 3/13; H01S 3/00

(52) U.S. Cl. 372/29.021; 372/38.02

(57) ABSTRACT

The invention relates to adjustment of optical output power and extinction ratio. A laser cuts resistors to obtain a desired resistance value, thereby adjusting an automatic power control loop circuit. Since several cuttable resistors and other components can be welded with Surface Mount Technology (SMT), process is simplified, the stability of products is increased and the production costs are reduced.

This non-provisional application claims priority under U.S.C.§ 119(a) on Patent Application No(s). 094105752, filed in Taiwan, Republic of China on Feb. 25, 2005, the entire contents of which are hereby incorporated by reference.

### BACKGROUND

The disclosure relates to a system for adjusting the characteristics of a light source in an optical transceiver, and more particularly to a system and method utilizing cuttable transistors to adjust optical output power and extinction ratio of an optical transceiver.

The characteristics of light sources, for example, laser diodes (LD) and vertical cavity surface emitter lasers (VCSEL), contained in some components, such as an optical transceivers, vary in response to different environmental temperatures, wherein the light sources degrade after use for a long time. Thus there are components, known as an automatic power control (APC) loop circuit are usually built into a light sources driver to adjust optical output power. The automatic power control loop circuit adjusts the optical output power of the light sources with coupling control resistors of requisite resistance to maintain optical characteristics, such as mean launched power and extinction ratio. Such applications are very important for transmitters in optical transceivers.

FIG. 1 shows an optical transceiver 1 having a light source 10 and electrically connected to a driver 12 having an automatic power control loop circuit (not shown). The driver 12, such as a Mindspeed 2068, Maxim 3646 or the other, is electrically connected to a first control resistor 13, a second control resistor 14 and a power supply terminal 18 providing power to the system at the other end. Typically, the driver 12 generates a current corresponding to the instant optical output power of the light source 10, which causes a voltage drop at the first control resistor 13. After feedback from the automatic output power control loop circuit, the current generated by the automatic power control loop circuit corresponding to the optical output power is adjusted via the varied resistance of the first control resistor 13. Variations in the optical output power of the light source 10 due to different environmental temperatures are thus minimized. Optical output power is kept constant and mean launched power is stable. Moreover, current generated by the automatic power control loop circuit to the light source 10 is modulated via the varied resistance of the second-control resistor 14 for better extinction ratio of the light source 10. Thus, characteristics of the light source, such as the mean launched power and extinction ratio, are adjusted by controlling the resistance of the first control resistor 13 and second control resistor 14 with the automatic power control loop circuit.

Conventionally, other methods are also employed to regulate control resistors. For example, a screwdriver can be used to adjust knobs of the first and second adjustable control resistors with glue fixing the knobs in position. This, however, increases manpower and cost. An additional external resistor can alternatively be used with the automatic power control loop circuit for adjustment of resistance value, at which the resistor is then welded. However, this complicates manufacturing steps. An EEPROM having the function of temperature sensing can also be used as a control resistor. After obtaining the characteristic curve of light sources, the EEPROM provides corresponding resistance to the light source with a conversion circuit in accordance with the characteristic curve. Such structure and method, however, are complicated and increase production costs. Finally an EEPROM functioning as a digital resistor can act as the control resistor with corresponding software, thereby writing requisite resistance values to the EEPROM after adjustment. This, however, also increases production costs. Such methods, in addition to being cost-ineffective, are typically not suitable for automated production.

### SUMMARY

The invention provides a system for adjustment of optical characteristics and method thereof. An external control modulator drives a laser cutting machine directly to cut cuttable resistors when a power control loop circuit in a driver light sources. Such method and system, in addition to being cost-ineffective are also suitable for automated production.

The invention is generally directed to a system for adjustment of optical characteristics. According to one aspect of the invention, the system includes a light source, a driver and a first cuttable resistor. The driver, having an automatic power control loop circuit, drives the light source. The first cuttable resistor is electrically connected to the driver. The system further includes a second cuttable resistor electrically connected to the driver. Moreover, the system further includes a laser cutting machine electrically connected to the driver and being controlled to cut the first cuttable resistor when adjusting the resistance of the first cuttable resistor.

According to another aspect of the invention, a method for adjustment of optical characteristics of a system, including a light source and a driver having an automatic power control loop circuit. The method includes steps of: welding a plurality of components of the driver and a first cuttable resistor to a substrate; electrically connecting a laser cutting machine to the automatic power control loop circuit of the substrate so that the automatic power control loop circuit generates a command to drive the laser cutting machine to cut the first cuttable resistor when the automatic power control loop circuit is adjusted; and generating a command from the automatic control loop circuit to stop the laser cutting machine after the adjustment of the automatic power control loop circuit is finished.

The method further includes a step of welding a second cuttable resistor to the substrate when welding a plurality of components and the first cuttable resistors. The automatic power control loop circuit generates a command to drive the laser cutting machine to cut the first and second cuttable resistors respectively when the automatic power control loop circuit is adjusted. The system is applied to an optical transceiver wherein the light source is a laser diode (LD) or vertical cavity surface emitter laser (VCSEL). Moreover, the cuttable resistors are cut by a laser, such as a Nd-YAG laser, thereby adjusting the resistance thereof. Furthermore, the cuttable resistors are surface mount device (SMD). The automatic power control loop circuit responds to resistance variations in the first cuttable resistor so as to control the optical output power variations in the light source at different temperatures to less than 1 dB, and the automatic power control loop circuit responds to resistance variations in the second cuttable resistor so as to control the amplitude of the current generated by the driver to the light source.

### DESCRIPTION OF THE DRAWINGS

The invention is described by way of exemplary embodiments, but not limitations, illustrated in the accompanying drawings in which like references denote similar elements, and in which:

FIG. 1 is a block diagram of a conventional system utilizing control resistors to adjust optical output power.

FIG. 2 is a block diagram illustrating a system utilizing cuttable resistors to adjust characteristics of the light source according to an embodiment of the invention.

FIGS. 3A˜3D are schematic diagrams illustrating methods of cutting the cuttable resistors.

FIG. 4 is a flowchart of a method utilizing cuttable resistors to adjust characteristics of the light source according to an embodiment of the invention.

### DETAILED DESCRIPTION

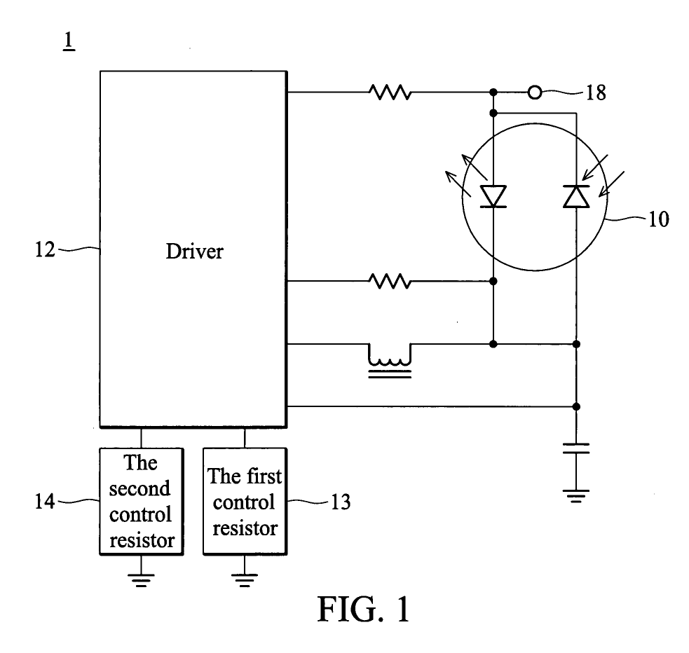

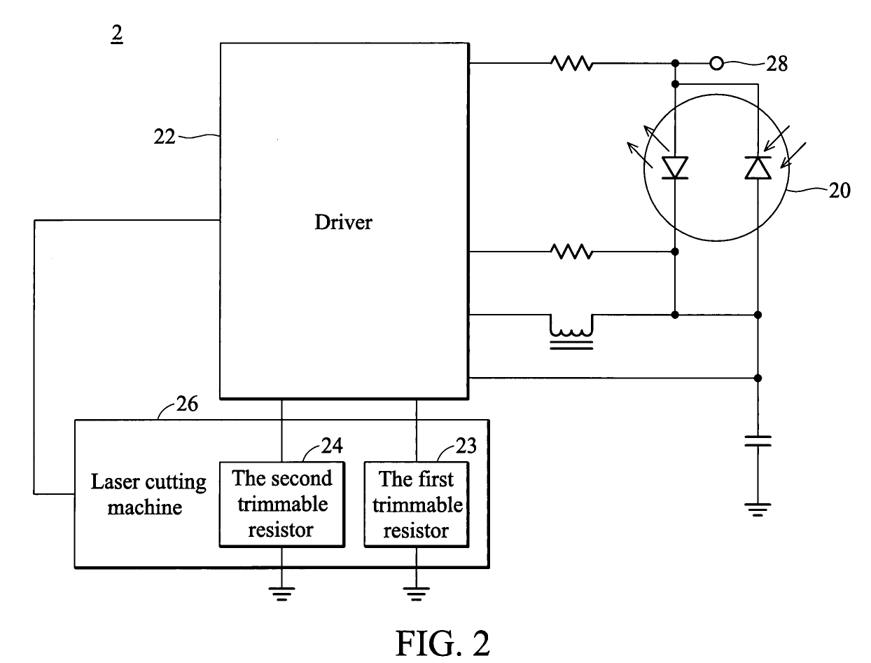

FIG. 2 illustrates an embodiment of the invention. The components in the optical transceiver 2 is similar to that in FIG. 1 except that the first control resistor 13 and second control resistor 14 are replaced by a first cuttable resistor 23 and a second cuttable resistor 24, respectively. The first cuttable resistor 23 and second cuttable resistor 24 are also electrically connected to a driver 22, and the driver 22 also has an automatic power control loop circuit like the driver 12 does. The driver 22 can be Mindspeed 2068, MAXIM 3646 or other components having similar functions in the market. The driver 22 is electrically connected to a light source 20 at one side and a power terminal 28 providing power supply required by the system at the other side. The light source 20 is preferably a laser diode (LD) or vertical cavity surface emitter laser (VCSEL).

Further, when the automatic power control loop circuit is adjusted, a laser cutting machine 26, electrically connected to a terminal of the driver 22, cuts the cuttable resistors. The laser cutting machine 26 may be set up by a user to receive a command from the automatic power control loop circuit in the driver 22 to cut the cuttable resistors synchronously. When the automatic power control loop circuit completes the adjustment, the laser cutting machine 26 stops at the same time, wherein the laser therein is preferably a Nd-YAG laser.

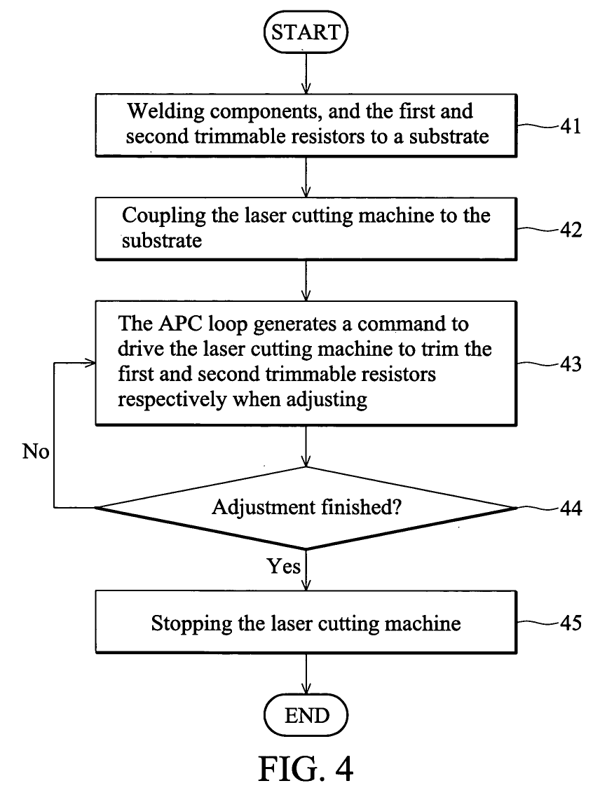

FIG. 4 shows a flowchart of an embodiment of the invention. A plurality of components of the driver 26, the first and second cuttable resistors 23 and 24, are welded to a substrate (not shown) in step 41. These components, the first cuttable resistor 23, and the second cuttable resistor 24, are preferably surface mount devices(SMD) welded in predetermined positions of the substrate by automatic apparatus during manufacture, thereby improving manufacturing efficiency and yield. In step 42, the laser cutting machine 26 is electrically connected to the substrate at one terminal, that is, to the automatic power control loop circuit in the driver 22. Proceeding to step 43, the automatic power control loop circuit in the driver 22 generates a command to drive the laser cutting machine 26 to cut the first and second cuttable resistors 23 and 24 respectively when the automatic power control loop circuit in the driver 22 is adjusted. The resistance value of the first cuttable resistor 23 or second cuttable resistor 24 increases when being cut by the laser. After feedback via the automatic power control loop circuit, the current and extinction ratio corresponding to the instant optical output power of the driver 22 is obtained. It is determined whether the adjustment of the automatic power control loop circuit is finished in step 44 according to preset determination parameters. If not, step 43 is repeated for further adjustment. If so, the automatic power control loop circuit in the driver 22 generates a command to the laser cutting machine 26, stopping cutting in step 45. The laser cutting machine 26 is then removed, so that the configuration of optical characteristics required by the optical transceiver 2 is completed.

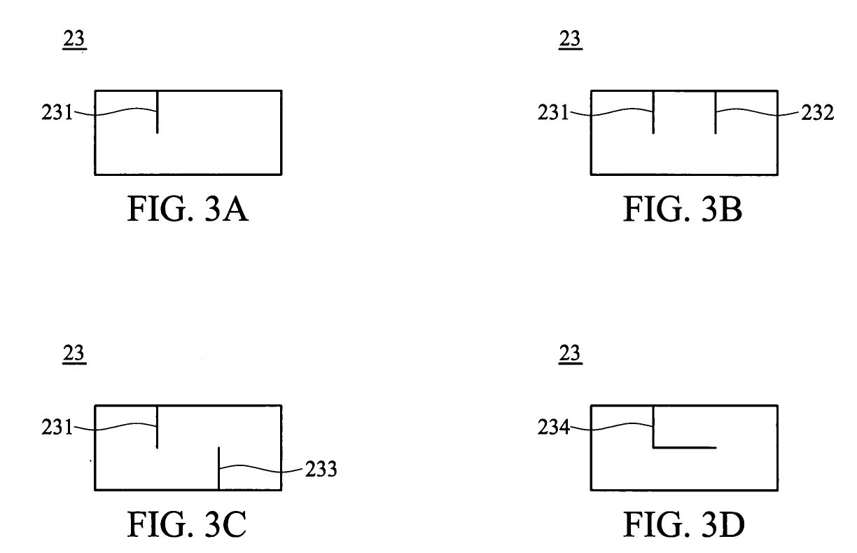

FIGS. 3A˜3C show methods of cutting the cuttable resistors by the laser cutting machine. For example, with reference to FIG. 3A, the laser cutting machine cuts the first cuttable resistor 23 along a scribe line 231, thereby reducing the current transmission ability thereof, that is, the resistance thereof is increased. Similarly, the laser can also cut the first cuttable resistor 23 along two scribe lines 231 and 232 or 231 and 233 as shown in FIGS. 3B and 3C respectively. When the automatic power control loop circuit is adjusted, the resistance value of the first cuttable resistor 23 increases when being cut by the laser. Alternatively, the first cuttable resistor can also be cut by the laser along the scribe line 234 as shown in FIG. 3D.

Embodiments of the invention utilize cuttable resistors to adjust the optical output power of the driver, wherein the cuttable resistors can be welded to the substrate with other components and then be adjusted to a desired resistance so as to avoid complicated manufacturing steps and reduce production cost. The laser cutting machine in the embodiment can directly receive a command from the automatic power control loop circuit of the driver 22, whereby enabling automation and further reducing production costs.

While the invention has been described by way of example and in terms of preferred embodiment, it is to be understood that the invention is not limited thereto. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A system for adjustment of optical characteristics comprising:
a light source;
a driver driving the light source and comprising an automatic power control loop circuit; and
a first cuttable resistor electrically connected to the driver.

2. The system of claim 1, wherein the automatic power control loop circuit responds to resistance variations in the first cuttable resistor so as to keep the optical output power of the light source constant, or control optical output power variations in the light source at different temperatures to less than 1 dB.

3. The system of claim 1, wherein the automatic power control loop circuit responds to resistance variations in the first cuttable resistor, whereby controlling an amplitude of a current generated by the driver to the light source.

4. The system of claim 1, further comprising a second cuttable resistor electrically connected to the driver.

5. The system of claim 4, wherein the automatic power control loop circuit responds to resistance variations in the first and second cuttable resistors so as to keep the optical output power of the light source constant and control an amplitude of a current generated by the driver to the light source respectively.

6. The system of claim 4, wherein the automatic power control loop circuit responds to resistance variations in the first cuttable resistor so as to control the optical output power variation of the light source at different temperatures to less than 1 dB, and the automatic power control loop circuit responds to resistance variations in the second cuttable resistor so as to control an amplitude of a current generated by the driver to the light source.

7. The system of claim 4, wherein the first cuttable resistor and/or the second cuttable resistor is cut by a laser, adjusting the resistance thereof.

8. The system of claim 7, wherein the laser is a Nd-YAG laser.

9. The system of claim 7, wherein the first cuttable resistor and/or the second cuttable resistor is a surface mount device.

10. The system of claim 1, wherein the light source is a laser diode (LD) or vertical cavity surface emitter laser (VCSEL).

11. The system of claim 1, wherein the system is applied to an optical transceiver.

12. The system of claim 1, further comprising a laser cutting machine electrically connected to the driver and being controlled thereby to cut the first cuttable resistor when adjusting the resistance of the first cuttable resistor.

13. A method for adjustment of optical characteristics of a system, comprising a light source and a driver with an automatic power control loop circuit, comprising steps of:
welding a plurality of components of the driver and a first cuttable resistor to a substrate;
electrically connecting a laser cutting machine to the automatic power control loop circuit of the substrate so that the automatic power control loop circuit generates a command to drive the laser cutting machine to cut the first tirmmable resistor when the automatic power control loop circuit is adjusted; and
generating a command from the automatic control loop circuit to stop the laser cutting machine after the adjustment of the automatic power control loop circuit is finished.

14. The method of claim 13, wherein the automatic power control loop circuit responds to resistance variations in the first cuttable resistor so as to keep the optical output power of the light source constant or control optical output power variations in the light source at different temperatures to less than 1 dB.

15. The method of claim 13, wherein the automatic power control loop circuit responds to resistance variations in the first cuttable resistor, whereby controlling an amplitude of a current generated by the driver to the light source.

16. The method of claim 13, further comprising a step of welding a second cuttable resistor to the substrate.

17. The method of claim 16, wherein the automatic power control loop circuit responds to resistance variations in the first cuttable resistor so as to keep the optical output power of the light source constant, and the automatic power control loop circuit responds to resistance variations in the second cuttable resistor, whereby controlling an amplitude of a current generated by the driver to the light source.

18. The method of claim 16, wherein the automatic power control loop circuit responds to resistance variations in the first cuttable resistor so as to control the optical output power variations in the light source at different temperatures to less than 1 dB, and the automatic power control loop circuit responds to resistance variations in the second cuttable resistor so as to control an amplitude of a current generated by the driver to the light source.

19. The method of claim 16, wherein the first cuttable resistor and/or the second cuttable resistor is cut by a laser, thereby adjusting the resistance thereof.

20. The method of claim 13, wherein the automatic power control loop circuit generates a command to drive the laser cutting machine to cut the first and second cuttable resistors respectively when the automatic power control loop circuit is adjusted.
